(19) United States
(12) Patent Application Publication
(10) Pub. No.: US 2024/0117794 A1
(43) Pub. Date: Apr. 11, 2024

(54) HIGHLY STRETCHABLE FIBER WITH TUNABLE STIFFNESS AND APPLICATIONS

(71) Applicant: KING ABDULLAH UNIVERSITY OF SCIENCE AND TECHNOLOGY, Thuwal (SA)

(72) Inventors: Ragesh CHELLATTOAN, Thuwal (SA); Gilles LUBINEAU, Thuwal (SA)

(21) Appl. No.: 18/276,284

(22) PCT Filed: Feb. 11, 2022
(86) PCT No.: PCT/IB2022/051247

§ 371 Date: Aug. 8, 2023

Related U.S. Application Data
(60) Provisional application No. 63/148,766, filed on Feb. 12, 2021.

(51) Int. Cl. F03G 7/06; B25J 9/14; F15B 15/10

(52) U.S. Cl. CPC F03G 7/061; B25J 9/144; F03G 7/0616; F15B 15/10

(57) ABSTRACT

A hybrid fiber with tunable stiffness includes a stiff fiber, a soft fiber connected in series to the stiff fiber, and a locking mechanism in contact with the soft fiber and configured to prevent the soft fiber from extending during a locked state, and to allow the soft fiber to extend during an unlocked state. The hybrid fiber has a substantially zero-bending resistance, irrespective of whether the soft fiber is in a locked or an unlocked state.

### CROSS-REFERENCE TO RELATED APPLICATIONS

This application claims priority to U.S. Provisional Patent Application No. 63/148,766, filed on Feb. 12, 2021, entitled “HIGHLY STRETCHABLE FIBER WITH TUNABLE MEMBRANE STIFFNESS FOR PROGRAMMABLE SHAPE CHANGE IN SOFT ROBOTS,” the disclosure of which is incorporated herein by reference in its entirety.

### BACKGROUND

### Technical Field

Embodiments of the subject matter disclosed herein generally relate to a stiffness controllable fiber that is capable to be switched on and off between being stretchable and rigid, and more particularly, to a stiffness tunable hybrid fiber, which includes soft and stiff parts connected in series and the soft part has a locking mechanism for locking and unlocking the soft part.

### Discussion of the Background

An adaptable shape change is necessary for soft robots to perform multiple tasks. An example is the shape change in a soft pneumatic manipulator (e.g., an artificial hand) that can change its shape to more than one configurations through pressure control in different chambers associated with the manipulator. However, adaptive shape changes in a soft pneumatic manipulator are a challenge because they need a complicated modular design, with each module having 2 to 4 chambers. Moreover, the multi-chambers configuration demands an equal number of tubes and flow control valves, making the manipulator system more complex.

Thus, a current significant limitation of many shape change demonstrations in soft robots is the fixed path of motion, which restricts the variety of tasks performed by the manipulator. One of the necessary aspects of future soft robotic applications will be achieving an adaptable shape change, which is necessary to perform multiple tasks. In nature, although most fluid-filled soft biological structures, such as the octopus arm, earthworm, and nematodes, are single-chambered soft bodies, and they can still change their body shape through change in their skin stiffnesses. A single-chambered pneumatic soft body that can tune its membrane stiffness can also produce a similar shape change whenever required, resulting in a straightforward system. For this, what we require is change in membrane stiffness without any significant increase in bending stiffness.

A membrane stiffness of a soft body is a resistance against the in-plane deformation, whereas a bending stiffness is a resistance against out-of-plane deformations. The manipulation process in a soft body involves two kinds of deformations: (1) in-plane stretching of a part of the soft body, which depends on the direction of motion, and (2) bending of the whole structure, which is independent of the direction of motion. For pneumatic manipulation, where flexure is the main motion, it is needed to stiffen the membrane response (membrane stiffness) at selected locations while preserving a minimal flexural rigidity (bending stiffness).

Existing stiffness tunable technologies [1] have some intrinsic limitations. For example, many demonstrated applications of tunable stiffness involve a significant increase in bending stiffness [2 to 6], which greatly affects the compliance of the soft body, and thus remain problematic when used for manipulation. For instance, [2] tunned the bending stiffness of fabric via glass transition of shape memory polymer. Other [4] focused either on tuning the bending stiffness of a gripper through softening-stiffening of a plastic material for high payload capacity or on obtaining a tunable compression/bending stiffness using alloys for both the gripper [5] and tensegrity architectures [6]. Others [7] worked on tuning the bending stiffness of a soft actuator via phase change of a low-melting-point-alloy, while [8] worked on reversible osmotic actuation and tuneable bending stiffness of a tendril-like soft robot. Others studies [9] focused on tunning the bending stiffness of a fiber-like structure through softening-stiffening of a thermoplastic material for high payload capacity or using a low melting point alloy (LMPA) [10]. However, these fibres, if used along the entire length of the soft manipulator for stiffness control, the sizable volume fraction of the rigid thermoplastic material or solid LMPA can introduce a high bending resistance to the manipulator, resulting in insufficient bending deformation even at a high pressure. Thus, all of the above discussed applications of tunable stiffness involve a significant increase in the bending stiffness, which greatly affects the compliance of the soft body, and thus remain problematic when used for manipulation.

Electro-Thermally activated shape memory thermo plastic polymer (SMP) can switch between a rigid solid (high bending stiffness) state and a partial rubbery state (soft). But the main drawback of this approach is the high bending stiffness in the solid state, which is a bottleneck for the manipulation process. In addition, this approach also requires a very high input voltage to achieve a high temperature of heating (>75° C.). On the other hand, technologies such as the magnetic-based approach requires a large set of machinery, the electro-active systems require a high driving voltage (kV), and the variable-stiffness twisted rubber requires a motor for each twisted rubber and even then, a change in stiffness is very small.

The only existing promising approach to achieve a high change in the membrane stiffness of a manipulator is based on vacuum assisted jamming. However, even this approach has the same drawbacks of the multi-chambered pneumatic manipulators, as it needs numerous tubes and flow controlling units. An ideal stiffness tunable system for soft manipulation should be compact in size, simple in operation, and produce a large change in membrane stiffness without introducing any significant change in the bending stiffness.

Thus, there is a need for a new soft robot manipulator having the ability to tune its membrane stiffness alone, and without affecting the flexibility or bending stiffness of the soft robot, and to also be able to produce similar shape changes whenever required, which will eliminate the need for multi-chamber and related flow control parts for pneumatic manipulation, thus resulting in a simple to manufacture and compact system.

### BRIEF SUMMARY OF THE INVENTION

According to an embodiment, there is a hybrid fiber with tunable stiffness, and the hybrid fiber includes a stiff fiber, a soft fiber connected in series to the stiff fiber, and a locking mechanism in contact with the soft fiber and configured to prevent the soft fiber from extending during a locked state, and to allow the soft fiber to extend during an unlocked state. The hybrid fiber has a substantially zero-bending resistance, irrespective of whether the soft fiber is in a locked or an unlocked state.

According to another embodiment, there is a soft robot system that includes a chamber having in inlet for receiving pressured air, a hybrid fiber with tunable stiffness located on an internal wall of the chamber, and a controller configured to control an amount of air inside the chamber and a temperature inside the hybrid fiber. The hybrid fiber a stiff fiber, a soft fiber connected in series to the stiff fiber, and a locking mechanism configured to prevent the soft fiber from extending during a locked state, and to allow the soft fiber to extend during an unlocked state.

According to yet another embodiment, there is a method for controlling a shape of a chamber associated with a soft robot system. The method includes inflating the chamber with air to bend the chamber, and activating a locking mechanism of a hybrid fiber, to reduce a stiffness of the hybrid fiber, wherein the hybrid fiber is attached with two ends to an internal wall of the chamber. A bending of the chamber is reduced as a result of activating the locking mechanism as the internal wall becomes less stiff. The hybrid fiber includes a stiff fiber, a soft fiber connected in series to the stiff fiber, and the locking mechanism, which is fully encapsulated within the soft fiber.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a hybrid fiber with tunable stiffness;

FIG. 2 illustrates a deformable chamber provided with a hybrid fiber with tunable stiffness;

FIG. 3 illustrates an activation of the deformable chamber of FIG. 2 when a locking mechanism of the hybrid fiber is triggered;

FIG. 4 illustrates the internal configuration of the locking mechanism of the hybrid fiber;

FIG. 5A illustrates a degree of deformation of the deformable chamber as the locking mechanism is activated, FIG. 5B plots the manipulation angle versus a differential stiffness at various pressures, and FIG. 5C shows a schematic diagram of a bidirectional bending of the single-chambered body of FIG. 5A;

FIG. 6 illustrates the composite modulus of a hybrid fiber as a function of the volume fraction of the stiff fiber;

FIG. 7A illustrates a chamber having two hybrid fibers, FIG. 7B shows the modulus of the hybrid fiber versus the volume fraction of the stiff fiber, FIG. 7C shows a semi-logarithmic plot of the hybrid fiber's effective modulus versus the volume fraction of the stiff fiber, and FIG. 7D illustrates the stress experienced by the hybrid fiber versus the strain;

FIG. 8A illustrates how the semi-logarithmic plot of the hybrid fiber's effective modulus versus the volume fraction of the stiff fiber is used to select the fibers for the hybrid fiber, FIG. 8B illustrates one implementation of the hybrid fiber based on the plot of FIG. 8A, and FIG. 8C illustrates the entire hybrid fiber being encapsulated within a same material as the soft fiber;

FIG. 9A illustrates a force-displacement of the stiffness of a tunable hybrid fiber for three heating-cooling cycles, FIG. 9B illustrates the results of a tensile test of the hybrid fiber before and after unlocking the soft part, and FIG. 9C illustrates the change in tensile modulus before and after unlocking the different volume fraction of the soft part of the hybrid fiber;

FIG. 10A illustrates the change of the gallium material as the heater is activated, FIG. 10B illustrates the force-time curve to evaluate the time for unlocking the soft fiber with an active heating using 1 W input power, and FIG. 10C illustrates the time for unlocking the soft fiber when heated with various input powers;

FIG. 11 shows a displacement-time curve that is used to determine the time of stiffness recovery;

FIG. 12 shows a soft robot chamber having two pairs of hybrid fibers for double bending the chamber; and

FIG. 13 is a flow chart of a method for bending a chamber with a hybrid fiber.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a hybrid fiber having a single locking mechanism. However, the embodiments to be discussed next are not limited to such a configuration, but may be applied to fibers having plural locking mechanisms or to systems having plural hybrid fibers.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel hybrid fiber includes a stiff fiber connected in series with a soft fiber. The soft fiber is provided with a locking mechanism that can be controlled, for example, remotely, to allow the soft fiber to expand (unlocked state) or to prevent the soft fiber to expand (locked state). In the locked state, the soft fiber, which is otherwise flexible and stretchable, is prevented from being stretchable. Note that the soft fiber remains soft and stretchable, but a locking mechanism provided within the soft fiber, like a spine, prevents the soft fiber to extend or contract. In the unlocked state, the spine melts away and the soft fiber is freed to extend. Thus, the flexibility of the soft fiber can be changed or adjusted when a signal is sent by the user of the hybrid fiber to the spine of the soft fiber.

An implementation of the hybrid fiber is now discussed with the figures. From the following discussion, those skilled in the art would understand that many other materials may be used for the implementation of the soft fiber, rigid fiber, and the locking mechanism, according to the constraints and principles set up herein.

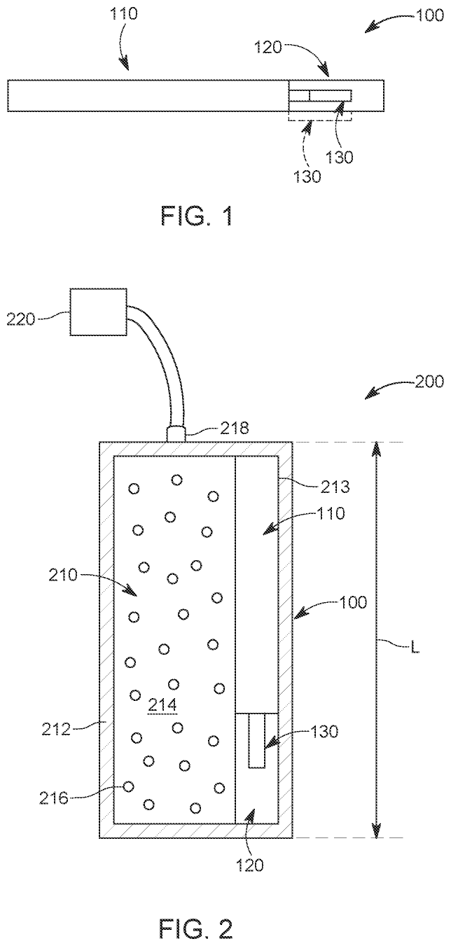

FIG. 1 illustrates a hybrid fiber 100 having an adjustable stiffness. The hybrid fiber 100 includes one or more non-stretchable fibers 110 (also called stiff fiber), one or more stretchable fibers 120 (also called soft fiber), and a locking mechanism 130 for each soft fiber. The stiff fiber 110 has a high membrane stiffness but almost zero bending stiffness. The locking mechanism 130 is fully located, in this embodiment, within the stretchable fiber 120 and has one end in direct contact with the non-stretchable fiber 110. However, in another embodiment, the locking mechanism 130 is fully located outside the stretchable fiber 120, as illustrated by the dash line in the figure. In yet another embodiment, the locking mechanism is partially inside the stretchable fiber and partially outside. The other end of the locking mechanism may be coupled to another stiff fiber. A non-stretchable fiber is considered herein a fiber that is stiff, i.e., not recognized in the art as being extensible or stretchable. A stretchable fiber is considered herein to be a fiber that is soft, i.e., extensible. In one application, a stretchable fiber is considered to be any fiber that is made of a material that has a relatively small Young modulus, e.g., smaller than 0.01 GPa, and a non-stretchable fiber is a fiber that is made of a material that has a relatively high Young modulus, e.g., equal to or larger than 5 GPa. For example, cotton, which has a Young modulus between 5 and 12 GPa, is considered to be a stiff or non-stretchable material while rubber, which has a Young modulus of about 0.01 GPa is considered to be soft or stretchable. Thus, in this embodiment, the stiff fiber is made out of cotton and the soft fiber is made out of rubber. However, in another embodiment, the stiff fiber may be made of any material that has the Young modulus larger than the Young modulus of the soft fiber.

The hybrid fiber 100 is also characterized by the volume fraction f1 of the stiff fiber 110, and the volume fraction f2 of the soft fiber 120. The volume fraction quantities f1 and f2 characterize what percentage of the total volume of the fiber is taken by the stiff and soft fibers, respectively. The volume occupied by the locking mechanism 130 is not counted when determining f1 and f2. Adding a small volume fraction of the soft fiber 120 to the stiff fiber 110 enables excellent stretchability for the newly formed hybrid fiber 100. The locking mechanism 130 inside the soft part helps to control the whole hybrid fiber's membrane stiffness. Typically, a hybrid fiber-containing up to 20% of soft matter features a substantial change in membrane stiffness and sufficient stretchability when the locking mechanism unlocks the soft part. When the locking mechanism locks the soft part, the hybrid fiber was found to regain its original stiffness value. In one embodiment, the hybrid fiber 100 was found to produce more than 100 times change in the membrane stiffness in less than 6 s using a trigger signal that uses less than 3 W of electrical power. One advantage of this embodiment is that because the volume fraction of the soft part 120, and thus, the locking mechanism 130, is very small, i.e., 20% or less of the total volume of the hybrid fiber, the rest 80% of the hybrid fiber 100 is composed of the stiff fiber 110, which has a zero-bending stiffness. Thus, the hybrid fiber 100 has a substantially zero-bending resistance, irrespective of whether the soft part 120 is in a locked (gallium solid) or an unlocked (gallium liquid) state. Note that the term “substantially zero-bending resistance” is understood herein to mean a hybrid fiber having less than 20% of its volume occupied by a soft fiber attached to a locking mechanism. Hence, the disclosed hybrid fiber 100 controls/affects only the membrane stiffness without affecting its bending stiffness and is suitable for all soft robotic manipulation.

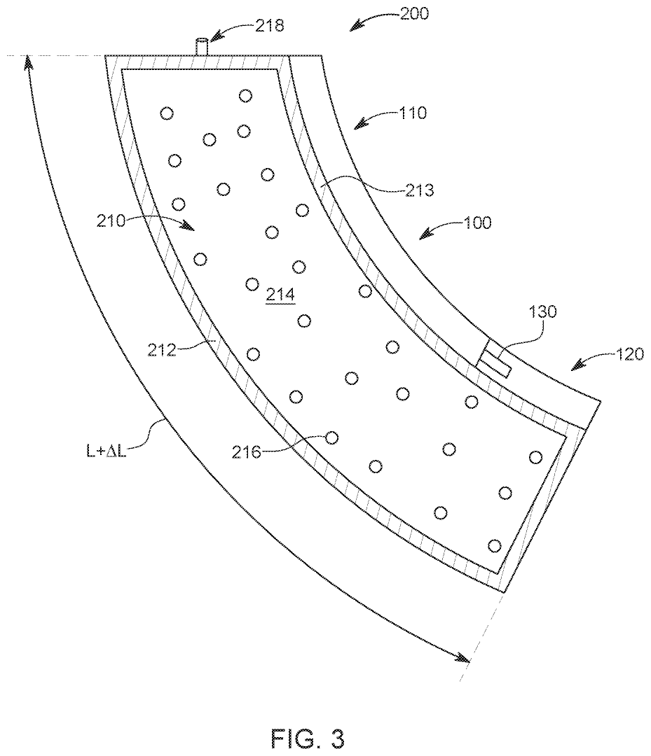

The hybrid fiber 100 shown in FIG. 1 can be attached to an air manipulator 210, as shown in FIG. 2, for achieving a desired deformation (shape control) for a soft robot system 200. The manipulator 210 has soft opposing walls 212 and 213, and an interior chamber 214 that is filled with air 216. The hybrid fiber 100 is attached to the wall 213 with both its ends. An inlet 218 fluidly connects a pump 220 to the chamber 214 for supplying compressed air. When more air is pumped inside the chamber 214 and the locking mechanism 130 is locked, the soft wall/membrane 212 extends and bends while the soft wall/membrane 213 is prevented, by the locking mechanism 130, from extending, as illustrated in FIG. 3. Note that an original length L of the wall 212 of the manipulator 210 (see FIG. 2) is smaller than the length of the wall 212 in FIG. 3 due to this process, which results in the overall bending of the manipulator 210 in one direction, i.e., towards the locked wall. This overall bending of the manipulator 210 is used in soft robot applications for picking up objects.

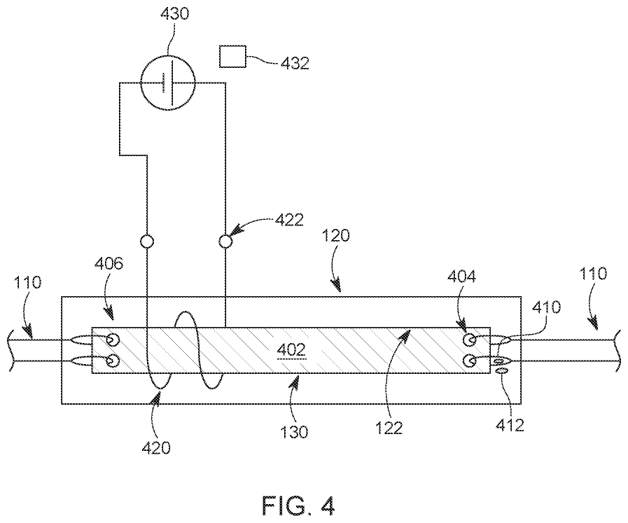

The locking mechanism 130 may be implemented in this embodiment based on a phase change material property. For example, if a material 402, having a low melting point is selected, this material may be placed inside a sealed chamber 122 formed within the stretchable fiber 120, as shown in FIG. 4. Note that the material 402 may fully or partially occupy the sealed chamber 122. The figure shows the sealed chamber 122 being fully occupied by the material 402. In one embodiment, the material 402 may be a metal, for example, gallium (Ga). Other materials that have a low melting point and have enough structural strength when in the solid state may be used. The material 402 may have a connecting mechanism 404 for connecting to the non-stretchable fiber 110. In this embodiment, the connecting mechanism 404 includes one or more holes 406 formed at each end of the material 402. The non-stretchable fiber 110 may be passed through a corresponding hole 406 (plural such fibers are shown in the figure, but any number of fibers may be used) to tightly connect the fiber to the material 402. In one embodiment, each end of the material 402 may be connected to the fibers 110. Other implementations of the connecting mechanism 404 may be used as long as a strong connection is achieved between the material 402 in its solid state and the fiber 110.

The material of the fiber 120 is formed along and around the material 402 for fully enclosing the material 402. If the non-stretchable fiber 110 passes through the holes 406, and the non-stretchable fiber 110 is made of cotton and the soft fiber 120 is made of rubber, then the rubber adheres very well to the non-stretchable fiber 110 and thus, the sealed chamber 122 is achieved without the addition of any other material. However, if the two fiber materials are not compatible with each other (i.e., no good bonding between them is achieved), or a material 410 different from the non-stretchable fiber 110 is used to connect the hole 406 to the non-stretchable fiber 110, as also illustrated in FIG. 4, then a bonding material 412 may be used between the material 410 and the fiber 120 to ensure the sealing of the chamber 122. The sealing of the chamber 122 is desired to prevent the leaking out of the material 402 when in a fluid state, i.e., when the locking mechanism is in the unlocked state.

To control the state (solid or liquid) of the material 402 in this embodiment, a Joule heater 420 is placed next and/or around the material 402, as illustrated in FIG. 4. The Joule heater 420 may be a conductor wire that has pads 422 for being connected to a power source 430. The electrical current flowing through the Joule heater 420 heats the wire and consequentially the material 402, until it melts. Thus, the solid state of the material 402 is changed to fluid state. When the material 402 becomes fluid inside the chamber 122, the stretchable fiber 120 is unlocked and is free to expand if a force is applied by the non-stretchable fiber 110 or by the air from the chamber 214. In this way, the hybrid fiber 100 becomes stretchable as the locking mechanism 130 has unlocked the stretchable fiber 120. When the Joule heater 420 is turned off, the material 402 changes from fluid to solid, and regains its strength, thus locking the stretchable fiber 120 so that cannot extend any more. Because the volume fraction of the stretchable fiber 120 is 20% or less, the hybrid fiber 100 possess negligible bending resistance irrespective of whether the soft part is in a locked (gallium solid) or an unlocked (gallium liquid) state, and thus, only the membrane stiffness is controlled through this process. It is noted that for soft robotic applications, the air pressure in the chamber 214 is released just before the Joule heater 420 is turned off, so that when the material 402 solidifies, it has the length that it had before the heater was turned on as the chamber 214 has deflated to its original size.

Upon cooling, the solidification of the material 402 allows the hybrid fiber to regain the original stiffness value. The hybrid fiber's stiffness could be controlled directly using a low voltage battery 430 and associated controller 432, resulting in a compact stiffness tunable system 200. Note that the controller 432 may be shared with the robot in which the hybrid fiber is implemented so that the controller 432 can also control the pump 220 that provides the compressed air to the manipulator 210. In one application, a few hybrid fibers were integrated around a single-chambered soft body manipulator, which helped to control its shape through membrane stiffness changes in various combinations of the hybrid fibers. While the phase changing of the material 402, e.g., gallium, has been achieved by using Joule heating, the locking mechanism may be activated by using other approaches, e.g., electro-statical or magnetic mechanisms. Because the volume fraction f2 of the stretchable fiber 120 is small relative to the volume fraction f1 of the non-stretchable fiber 110, the size of the locking mechanism 130 is small, making it easy to control the stiffness of the hybrid fiber with low-voltage equipment.

The locking mechanism 130 can be made as now discussed. A suitable mould can be 3-D printed with a specific design for casting a gallium structure as the locking mechanism. The size of the gallium structure depends on the volume fraction of the soft part. A nichrome wire of a given length is inserted in the middle of the mould, and the gallium is cast over it. The required number of cotton fibers were then attached at both ends of the gallium, forming an interconnected continuous stiff network. The whole structure is inserted in another 3D printed mould (e.g., 100 mm×4 mm×3 mm) for protection. A well-mixed degassed silicone is poured into the mould and allowed to cure for 10 hours at room temperature to get the final device. The extra length of the nichrome wire outside the gallium structure is trimmed, and copper wire is attached instead to ensure that most of the joule heating happened within the gallium.

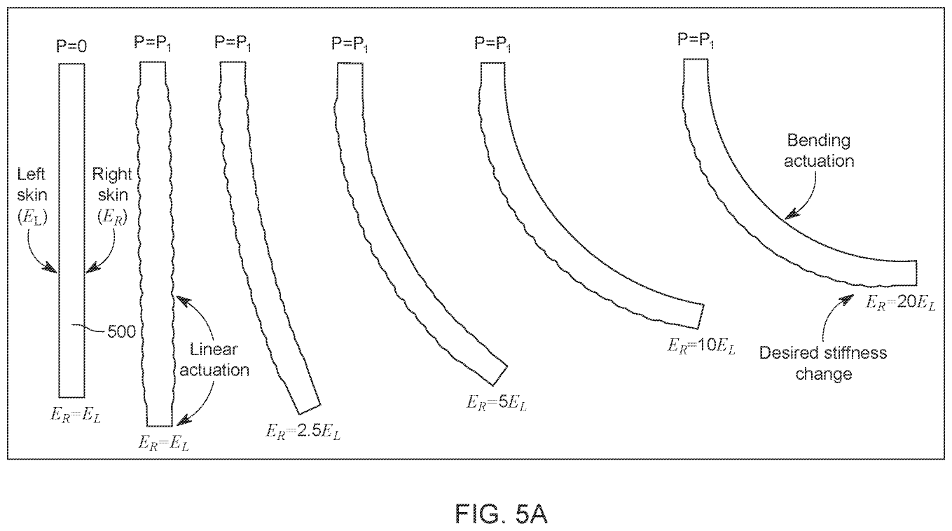

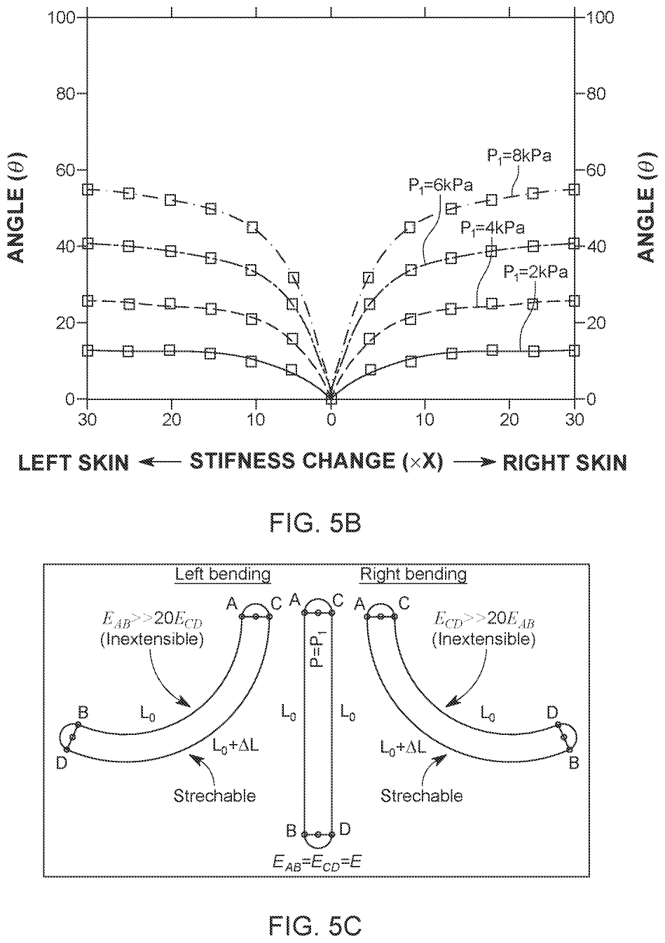

To characterize the hybrid fiber discussed above, the inventors have evaluated the correlation between a membrane stiffness change and the bending angle using finite element analysis on a soft body manipulator having the property of silicon rubber. For this analysis, the inventors considered a rectangular soft chamber 500 (corresponding to manipulator 210) as shown in FIG. 5A, with a stretchable skin on the left and right sides, and having a membrane stiffness of E_{L} and E_{R}, respectively. Initially, the membrane stiffness of the right skin E_{R} is kept equal to that of left skin E_{L}. Later, E_{R} is gradually increased up to 30×, and the corresponding change in bending is illustrated in the figure. FIG. 5A shows that when E_{R}=E_{L}, the soft body behaves as a linear actuator, i.e., when compressed air is pumped inside the chamber 500, it only changes its length and does not bend. However, with the gradual increase of E_{R}, which simulates the action of the locking mechanism for a hybrid fiber, the chamber starts to bend towards the right side. The bending angle gradually increased with the increase in the stiffness change of the right side. A plot of the achieved manipulation angle (towards left and right directions) vs. a differential stiffness at various pressures is illustrated in FIG. 5B. This analysis indicates that for a given pressure inside the chamber 500, the bending deformation increased quickly for stiffness changes up to 20×. This mechanism shows less efficiency as the bending evolution is slowing down for higher stiffness changes. For a given differential stiffness, the bending angle can be improved through higher input pressure but it requires more energy.

FIG. 5C shows a schematic diagram of bidirectional bending of the single-chambered body ABCD. To perform such manipulation, the skin of the soft body 500 must meet the following criteria. Under an applied pressure (P=P1), if the body wants to bend towards the left side, the skin on the left side (indicated by AB) should be inextensible (>20×), and the skin on the right side (shown by CD) should be extensible. This can be achieved if a first hybrid fiber is attached to the left side of the chamber 500. Similarly, when the desire is to bend the body towards the right side, the criteria is vice versa, i.e., a second hybrid wire needs to be attached to the right side of the chamber. Thus, having two hybrid fibers mounted inside the chamber, on opposite sides, can achieve both bending movements of the chamber 500. It is worth noting that in both cases, the bending stiffness of the chamber should be as low as possible. To facilitate bending actuation, a challenge is that the stiffening effect should only be related to a desired part of the membrane, and not the entire membrane. The locking mechanism 130 placed in a hybrid fiber 100 as discussed above is able to achieve these desired results by placing a hybrid fiber on each side of the chamber 500. By controlling the choice of stiffness for the hybrid fiber parts, their volume fraction, and the alignment, the stiffness property of the composite structure may be tailored to meet specific design requirements.

For example, consider two materials having a stiffness E₁ and E₂, and having corresponding volume fractions, f1 and f2. The two materials may be connected either in parallel or serial fashion (the hybrid fiber 100 shown in FIG. 1 is connected in series). The effective stiffness of the new parallel composite material, Eₚ, can be evaluated as follows,

$${σ}_{total} = {f}_{1} {σ}_{1} + {f}_{2} {σ}_{2} = {f}_{1} {E}_{1} {ε}_{x} + {f}_{2} {E}_{2} {ε}_{x} ⇒ {E}_{p} = \frac{{σ}_{total}}{{ε}_{x}} = {f}_{1} {E}_{1} + {f}_{2} {E}_{2} \qquad ( 1 )$$

and for the serial configuration, the effective stiffness, Eₛ, can be evaluated as,

$${ε}_{total} = {f}_{1} {ε}_{1} + {f}_{2} {ε}_{2} = {f}_{1} \frac{{σ}_{x}}{{E}_{1}} + {f}_{2} \frac{{σ}_{x}}{{E}_{2}} ⇒ {E}_{s} = \frac{{σ}_{x}}{{ε}_{total}} = \frac{{E}_{1} {E}_{2}}{{f}_{1}^{{E}_{2}} + {f}_{2}^{{E}_{1}}} . \qquad ( 2 )$$

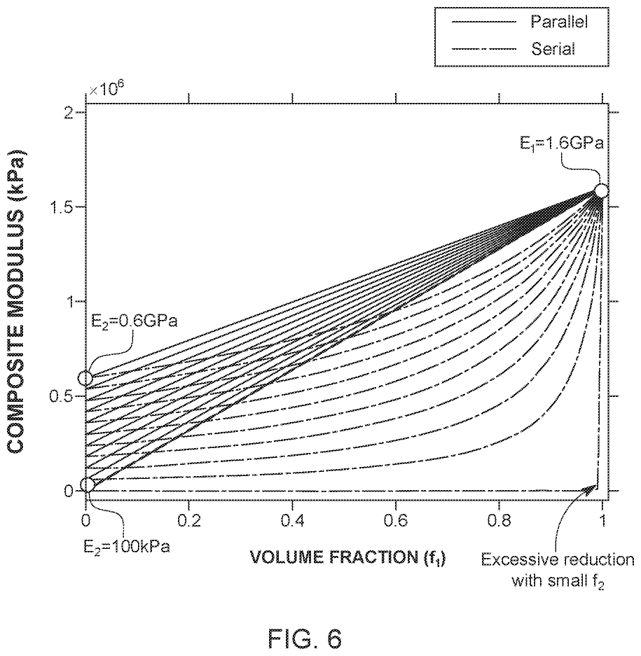

Equations (1) and (2) give the upper and lower bounds for the effective stiffness of the composite material discussed above while the hybrid fiber 100 falls under the category of the lower bound. FIG. 6 shows a plot of the effective stiffness of the hybrid structure with respect to the volume fraction of the first component (f₁), for both the serial and parallel connections, and for specific values of E₁ and E₂. The value of E₁ was kept highly stiff 1.2 GPa, whereas E₂ was assigned to have a range of values starting from moderately stiff 0.6 GPa to soft 100 kPa. Results show that for the parallel connection, the effective stiffness linearly varied with the variation of both E₂ and f₂. However, for the serial connection, there was a drastic change in the effective stiffness of the fiber for small values of f₂ when E₂ became softer and softer. The above analysis confirmed that a serial connection of small volume fraction (5-20% of total length) of a highly soft fiber (material of the soft fiber 120 having a modulus in the order of MPa, for example, smaller than 1 GPa) to a stiff fiber (material of fiber 110 having a modulus equal to one or more GPa), allows the newly formed hybrid fiber 100 to be highly stretchable, making it suitable for soft robotic application.

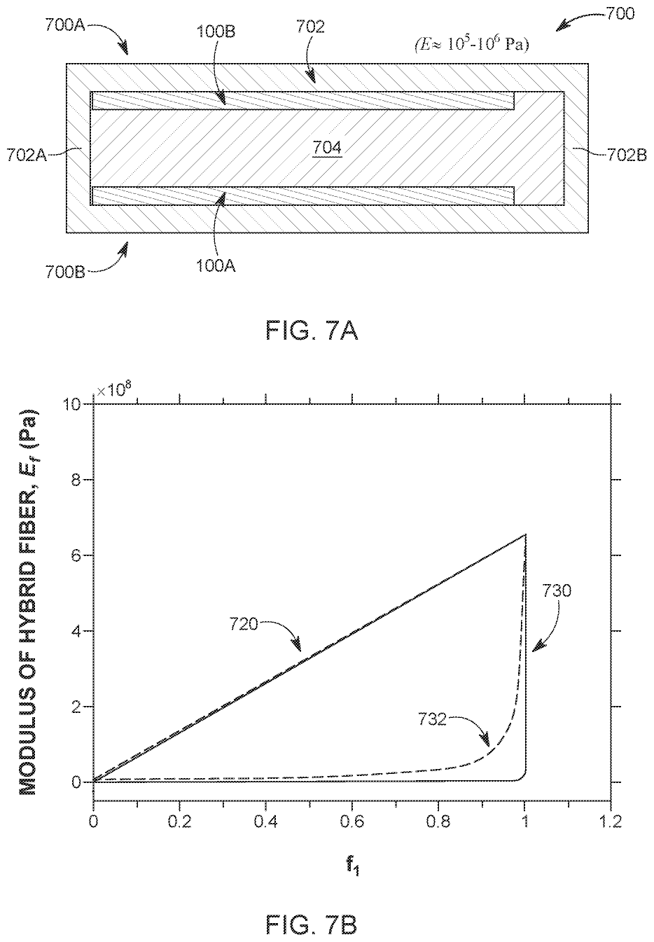

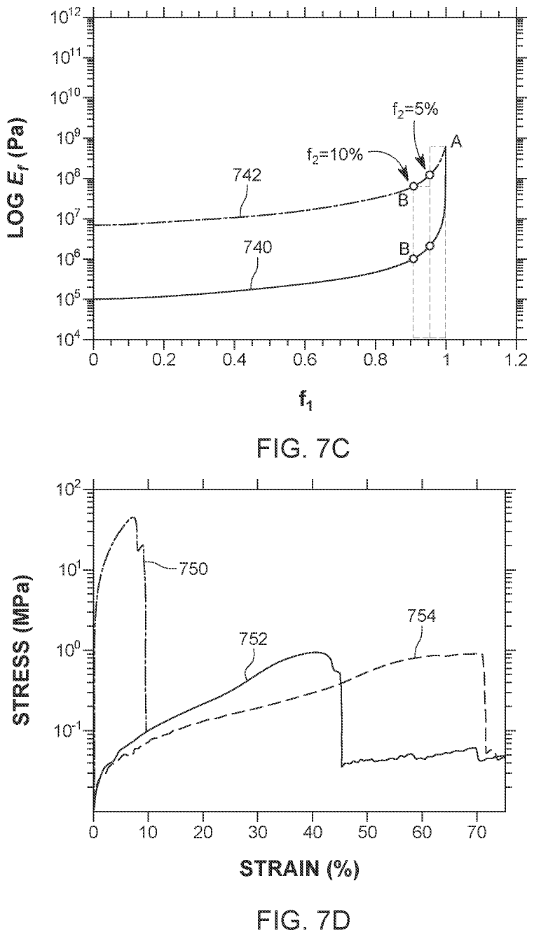

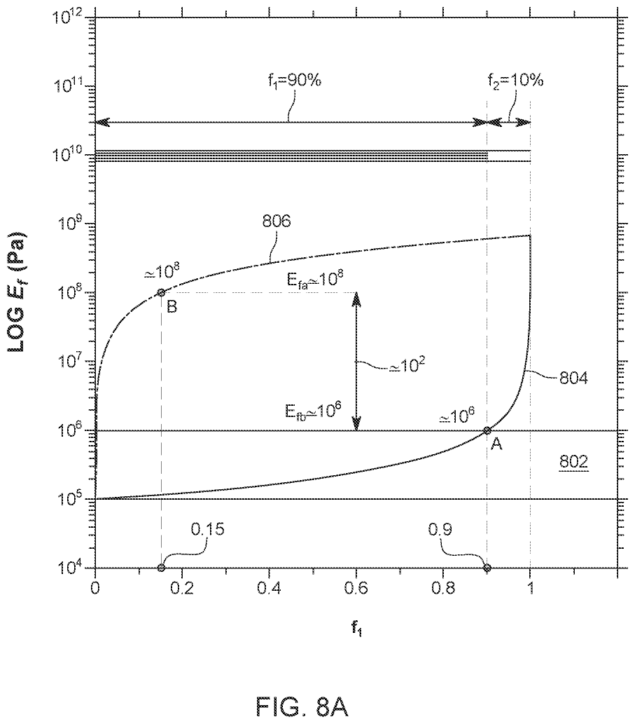

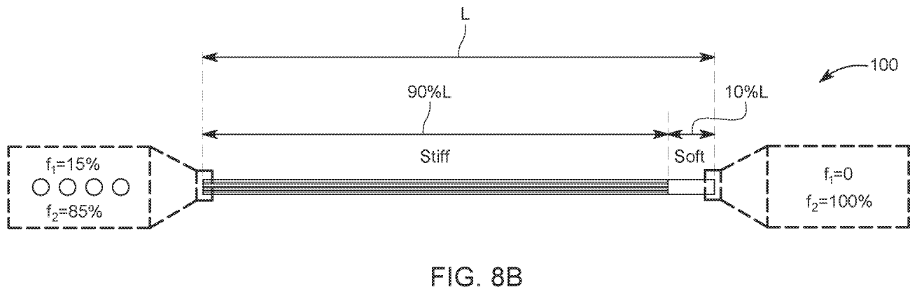

The integration of the hybrid fiber on the top 700A and bottom 700B skin 702 of a soft manipulator 700 is shown in FIG. 7A. An air channel or chamber 704 is shown inside the skin 702 and a top hybrid fiber 100A and a bottom hybrid fiber 100B are attached to the inside of the skin 702, on opposite walls. It is worth noting that the fibers that are part of the hybrid fibers are connected to the skin 702 only at its ends 702A and 702B. By introducing the locking mechanism 130 in the soft part of the hybrid fibers, these fibers can create on-demand stiffness asymmetry required for manipulation as discussed above with regard to FIG. 5A.

To obtain the highest stiffness change required for soft body manipulation applications, the inventors have adjusted the hybrid fibers design to determine the material choice for the stiff and soft parts, and the corresponding volume fractions. For this stage, it is desirable to understand the factors affecting the hybrid fibers stiffness, especially in the two extreme states, i.e., unlocked (stretchable) and locked (inextensible) conditions. For this analysis, E₁ and E₂ are the stiffness, and f₁ and f₂ are the volume fraction of the stiff and soft parts, respectively. Equation (2) discussed above indicates the effective stiffness of the hybrid fiber before locking is E_{fb}, which is given by:

$${E}_{fb} = \frac{{E}_{1} {E}_{2}}{{f}_{1} {E}_{2} + {f}_{2} {E}_{1}} . \qquad ( 3 )$$

After locking the soft part, the stiffness of the soft part E₂ will theoretically increase to infinity, and thus, the effective stiffness E_{fa} becomes

$${E}_{f a} = \frac{{E}_{1}}{{f}_{1}} . \qquad ( 4 )$$

Thus, the ratio of the stiffness change between the two states, before and after locking, is given by:

$$\frac{{E}_{f a}}{{E}_{f b}} = 1 + \frac{{f}_{2}}{{f}_{1}} \frac{{E}_{1}}{{E}_{2}} . \qquad ( 5 )$$

From the above equation, it is observed that a large stiffness change after locking is obtained by having f₂ much larger than f₁ or E₁ much larger than E₂ or both. However, f₂ and, in a smaller way, f₁, have some design considerations. For example, a higher value of f₂ will lead to a larger quantity of the material 402 that forms the switch, which is undesirable because upon solidification, it will result in a high bending stiffness, which will become a bottleneck for the manipulator. Therefore, it is desirable to keep f₂ as low as possible. Thus, the most appropriate option to increase the manipulator's stiffness change after locking is to use a material with a significantly large tensile modulus for the stiff part and low modulus for the soft part, i.e., E₁>>E₂.

To obtain the highest stiffness change after locking, in one embodiment the hybrid fiber 100 uses cotton fibers (0.66 GPa) for the stiff part 110 and commercially available silicone rubbers (ELASTOSIL®, E₂≈7 MPa or ECOFLEX®, E₂≈0.1 MPa) for the soft part 120. In this regard, FIG. 7B illustrates the effective modulus of the hybrid fiber 100 using these two materials. For the parallel combination, the modulus linearly decreased with the volume fraction of the soft part as indicated by curve 720. However, for the serial connection, the choice of ECOFLEX® rubber showed an abrupt change in the modulus when compared to ELASTOSIL® rubber, as illustrated by curves 730 and 732, respectively. A semi-logarithmic plot of the hybrid fiber 100's effective modulus (LogE_{f}) with respect to f₁ in the serial connection is shown in FIG. 7C. Adding 5% percentage of ECOFLEX® rubber, drastically reduced the effective stiffness (curve 740) when compared to that of ELASTOSIL® (curve 742) for the serial combination. At 10% volume fraction (indicated by point B), the effective stiffness of cotton-ECOFLEX® hybrid fiber is in the range of 10⁶ Pa, comparable to that of most of the soft robotic body. In contrast, the stiffness of the cotton-ELASTOSIL® hybrid fiber is greater than 10⁷ Pa at point B, which is relatively high. Such a high stiffness fiber could be used for high-pressure applications. Thus, by either varying the volume fraction or by choosing a suitable grade of silicone rubber as the soft part, the novel hybrid fibers with a large range of membrane stiffness and stretchability can be produced. A tensile test on the cotton-ECOFLEX® serial hybrid fibers validates the above findings as shown in FIG. 7D. The tested pure cotton fiber possesses a high modulus, so it is inextensible as illustrated by curve 750. However, by adding 5% ECOFLEX® in series makes the cotton fiber soft and stretchable, as illustrated by curve 752. This hybrid fiber features a strain of 40% before rupture, which further increased to 70% when the volume fraction increased to 10%, as illustrated by curve 754.

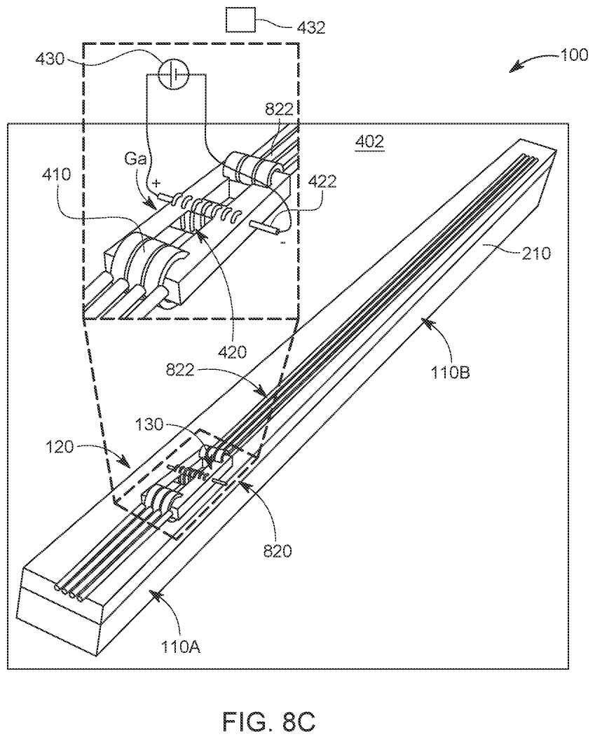

To determine the volume fractions of the stiff and soft parts that are needed to manipulate a given soft body for a stiffness range of about ≈10⁵ to 10⁶ Pa, the inventors used a design graph which is shown in FIG. 8A. The shaded region 802 indicates the stiffness range of a soft manipulator (Young's modulus ≈10⁵ to 10⁶ Pa). The curve 804 is a semi-logarithmic plot of the effective modulus of the hybrid fiber (LogE_{f}) based on ECOFLEX® and cotton fibers in serial connection, and the curve 806 indicates the same fibers in parallel connection. For a smooth manipulation, the effective stiffness of the serially connected hybrid fiber 100 should match the stiffness of the soft manipulator, which is the region where the curve 804 meets the rectangular area 402, i.e., at f₂=10% (point ‘A’ in FIG. 8A). From the graph in FIG. 8A, it can be seen that by using f₂=10 to 20%, it is possible to fabricate a hybrid fiber with a stiffness comparable to that of a given soft manipulator.

To fabricate the stiff part 110, in one embodiment, ECOFLEX® rubber and cotton was, but they need to be connected in a parallel configuration. For this configuration, 15% of the cross-section area of the ECOFLEX® rubber material was reinforced using a few cotton fibers in a parallel configuration (see FIG. 8B), which can raise the stiffness of the ECOFLEX® rubber material from about 10⁵ Pa to about 10⁸ Pa (which is indicated by point ‘B’ in FIG. 8A), making the fiber almost inextensible (stiff part). By serially adding this stiff material (90% of total length L) to pure stretchable ECOFLEX® rubber material (10% of total length L), it is possible to make the complete hybrid fiber 100 that is soft and stretchable (see FIG. 8B). The 10% soft part implies the approximate stiffness of the hybrid fiber will be 10⁶, as indicated by point ‘A’ in FIG. 8A. Once the soft part is locked, the whole fiber 100's stiffness will be increased, mainly depending on the stiffness of the stiff part 110, which is around 10⁸ as shown by point ‘B’ in FIG. 8A. Thus, based on this embodiment, it is possible achieve a stiffness change of around 10² before and after locking the soft part of the hybrid fiber as indicated in FIG. 8A. A stiffness change of 10² is relatively high in a stretchable material. FIG. 8C shows in more detail this hybrid fiber 100, having two stiff parts 110A and 110B that sandwich the soft part 120. Each of the stiff part 110A and 110B has the structure shown in FIG. 8B, i.e., a mixture of soft material 820 and stiff material 822, where the stiff material is encapsulated in the soft material. The soft part 120 includes the gallium locking mechanism 130, which includes the gallium material 402 and the heater 420. Note that in this embodiment, the entire hybrid fiber 100 is encapsulated in the soft material 820 and only the electrical ports 422 exit this material. This hybrid fiber is shown in FIG. 8C being attached to the outside of the manipulator 210.

A tunable-stiffness system 200 operated directly using low-power electrical pump 220, as illustrated in FIGS. 2, 3, and 8C is simple in operation, compact in size, and suitable for portable applications, due to the novel hybrid fiber 100. The system 200 shown in FIGS. 2, 3, and 8C includes a single air chamber 214 enclosed by a membrane 212 and has at least one hybrid fiber 100 on it. The hybrid fiber 100 may be located outside or inside the chamber 214. Depending on the complexity motion required by the system 200, plural hybrid fibers 100 may be placed on different walls/positions of the chamber 214. The hybrid fiber 100 illustrated in FIG. 4 uses a phase change locking mechanism 130, where the material 402 is gallium, a low melting point metal, due to its ease of fabrication, compactness, and simplicity in operation. The locking/unlocking mechanism 130 can be activated by solidifying/melting the gallium material 402. The small quantity of gallium in the locking mechanism 130 requires only a low electric power for the phase change, which ensures a faster response. To fabricate the stiffness tunable hybrid fiber 100, a thin gallium strip (e.g., width=0.8 mm, thickness=0.8 mm) along with a Nichrome heating wire, was placed in a tiny channel created within the soft part 120, which interconnects two stiff parts 110A and 110B, as shown in FIG. 8C. The Joule heating liquefies the gallium inside the channel, and disconnects the two stiff parts 110A and 110B from each other. As a result, the soft part 120 can get unlocked and becomes free to stretch. Upon cooling, the solidified gallium interconnects the stiff parts 110A and 110B to regain the original stiffness. FIG. 8B is a schematic diagram of an embodiment in which the hybrid fiber 100 has 10% of the soft part 120 along with the embedded gallium 402.

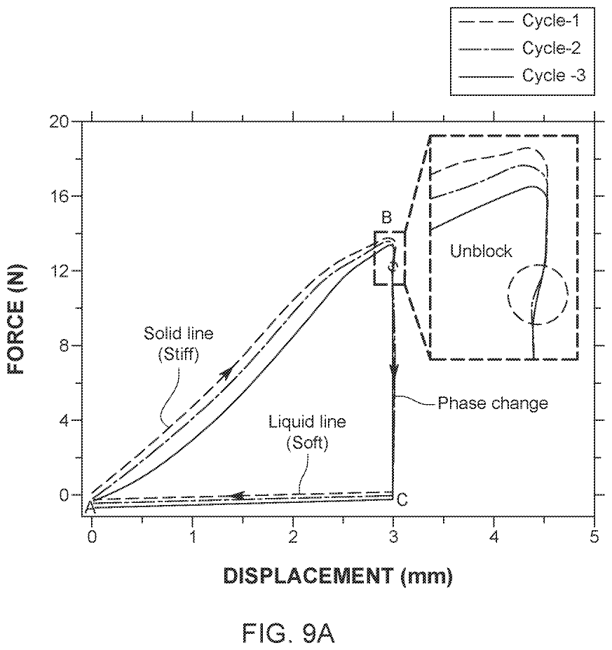

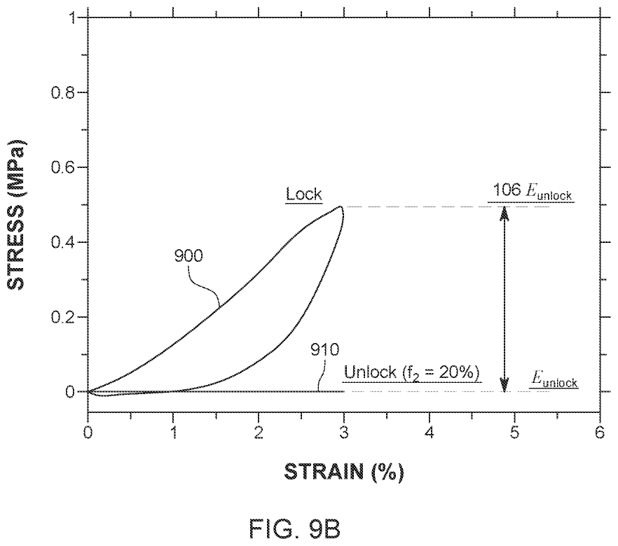

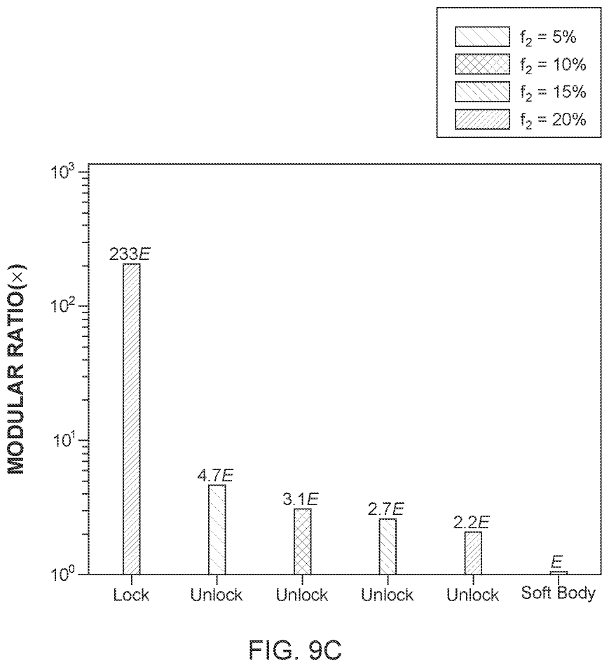

A repeatability analysis of hybrid fiber 100's stiffness change through heating and cooling of the gallium material in the locking mechanism 130 has been performed. FIG. 9A shows a force-displacement test performed on the hybrid fiber, with and without locking the soft part 120. The line AB indicates the force required to deform the hybrid fiber 100 from 0 to 3 mm, when the stretchable part 120 is locked (i.e., the gallium material 402 is in solid-state). A large force of 14 N at 3 mm indicates that the hybrid fiber is stiff. The gallium material is then heated, to transform it from the solid to the liquid phase using 3 W input power. The melted gallium material unlocks the soft part 120 and thus, the force dropped abruptly, as indicated by line BC. This large reduction in force illustrates the large hybrid fiber change in stiffness. After bringing the stiff fibers to the initial position (line CA), the gallium material is allowed to cool for stiffness recovery. The test was repeated for three cycles, and the graph shows excellent repeatability of cyclic stiffness change.

The magnitude of the stiffness change was evaluated before and after locking the hybrid fiber 100, as shown in FIG. 9B. The curves 900 and 910 illustrate the hybrid fiber's stress-strain when the gallium material is in the solid and liquid phases, respectively. The hybrid fiber exhibited a membrane stiffness change of around 106× between the two states, just using a 3 W input power. The fiber offers negligible bending resistance irrespective of whether the soft part is in a locked (gallium solid) or an unlocked (gallium liquid) state. This is so due to the low volume fraction of the soft part 120 (less than 20% of the entire fiber) and the corresponding gallium material 402 extending (partially or totally) only along this low volume. The stiffness change of about 106× is a large change in the membrane stiffness, which is good enough for shape change applications.

The change in stiffness with respect to the volume fraction of the soft part is illustrated in FIG. 9C. As the f₂ increased from 5% to 20%, the stiffness in the unlocked state decreased gradually and got closer to that of the manipulator's soft body (E). The locked hybrid fiber is 200× stiffer than the soft body. However, when 5, 10, 15, and 20% of the total length were unlocked step by step, the fiber's stiffness also reduced to 4.7×, 3.1×, 2.7×, 2.1×, respectively, with respect to the soft body.

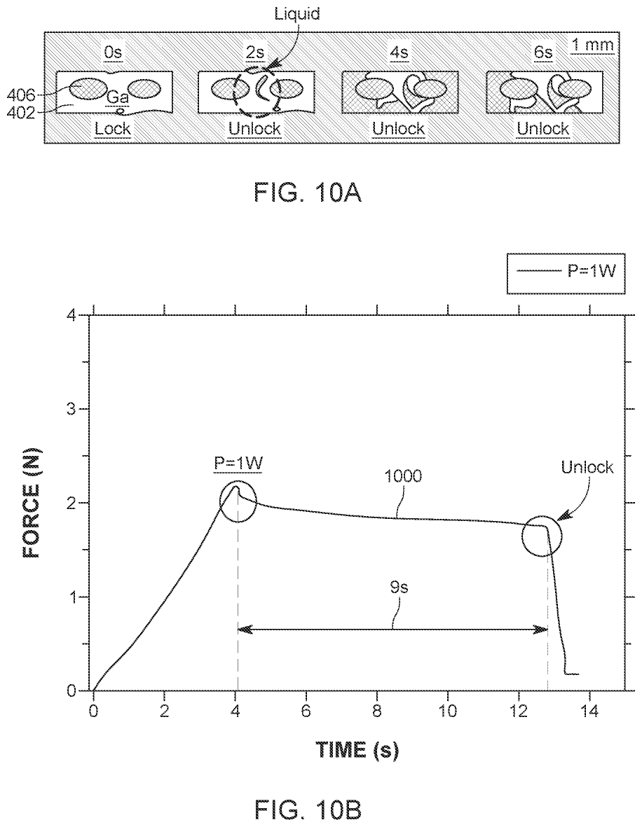

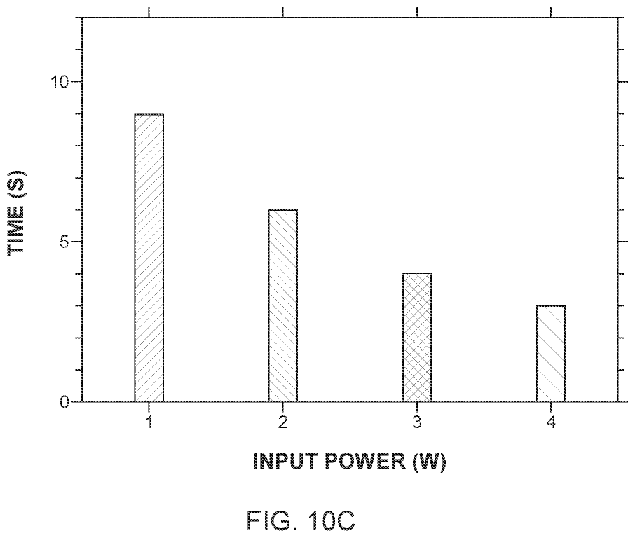

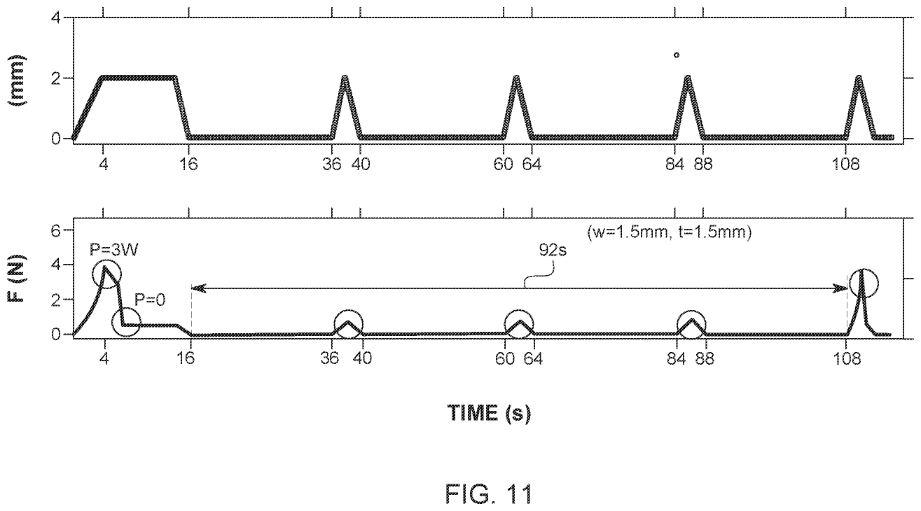

The response time of the stiffness change of the hybrid fiber has also been investigated. The soft part 120's volume fraction is small in the studied hybrid fiber 100. Thus, the quantity of gallium material required for the locking mechanism 130 is minimal, which ensures a low enthalpy of fusion and a faster response. For the response time investigation, various hybrid fibers with different gallium structures of various thicknesses fabricated. FIG. 10A illustrates the gallium's (width=1 mm, thickness=1 mm) phase change under 3 W input power. The gallium material begins to melt at around 2 s, and most of the volume is melted after 6 s, as illustrated in the figure. This shows that the time for unlocking the stiff fibers can be less than 6 s with a 3 W input power. FIG. 10B shows a force-time curve 1000, in which the force in the unlocked fiber is reduced from 2 N (stiff) to around 0 N (soft) in 9 s, with a 1 W input power. The time required for the stiffness change for different input power is illustrated in FIG. 10C. This figure shows that the higher the input power, the lower the time required. However, for the case of stiffness recovery, the process is due to the passive cooling. Thus, the recovery time depends mainly on the dimensions of the gallium structure, the volume fraction of the melted gallium inside the channel, and the passive cooling rate. The time required for the original stiffness to be regained using a gallium structure is shown in FIG. 11. This figure shows (displacement at the top and force at the bottom panel) a consistent time for regaining its stiffness. The experiments performed by the inventors also revealed that for a gallium structure having a width and thickness of 1.5 mm, the earliest stiffness recovery happened at 92 s. When the same dimensions were reduced to 1 mm and 0.5 mm, the earliest regain time happened at 44 s and 20 s, respectively. In general, it was observed that the smaller the size of the gallium structure, the quicker the stiffness regain. However, the gallium structure could not be minimized over a certain threshold in order to not compromise the load bearing capacity.

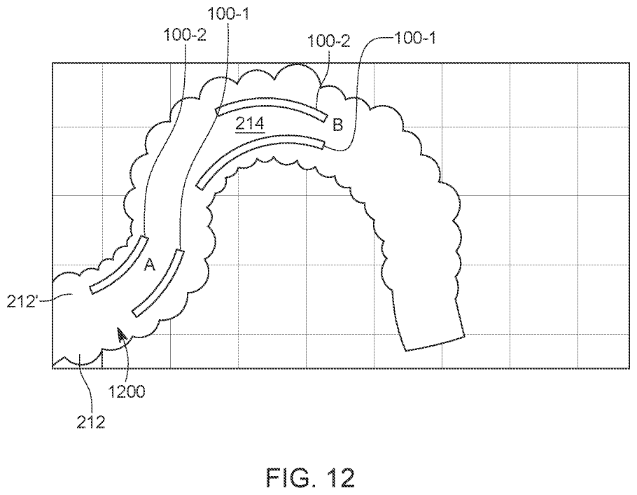

The stiffness tunable hybrid fiber 100 discussed above can allow or resist dimensional changes, depending on the phase of the material 402 inside the soft part 120. Fibers with tunable stiffness properties are useful for programmable shape change in single-chambered soft bodies to behave like a simple manipulator. FIG. 12 shows a complex shape change of a single-chambered soft rectangular body 1200, integrated with stiffness tunable hybrid fibers inside the chamber 214. The fabricated rectangular soft body has two stretchable skins 212 and 212′ on opposite sides. Two hybrid fibers 100-1 and two hybrid fibers 100-2 having f₂=20%, were fixed on each of the two skins 212 and 212's respectively. Only the ends of the hybrid fibers were glued to the soft body, and the rest of the fiber parts were free to move inside the channel. Initially, the hybrid fibers were in a locked state, which tends to prevent any dimensional change under a load. Then the hybrid fibers on the skin 212 and the hybrid fibers on the skin 212′ were unlocked using a suitable input power. The reduction in the membrane stiffness allowed dimensional changes of the skin under an applied pressure. The resulted stiffness asymmetry determines the structure to bend upwards for a region A, and downward for a region B, as illustrated in FIG. 12. This is possible because the locking mechanism controls only the membrane stiffness of the skin 212 or 212′ locally, without affecting the bending stiffness of the soft robot. The structure is then taken back to its initial position and the gallium is cooled to regain the fiber's initial stiffness. The process can be repeated as desired. In one embodiment, only a subset of the fibers is activated to obtain other deformations.

The novel hybrid fiber's stiffness depends upon the stiffness and volume fraction of the constituent components. The hybrid fiber 100 shown that a low tensile modulus of the soft part ensured high stretchability that is needed for shape change applications. The hybrid fiber's stiffness could be tuned by locking and unlocking the soft part, for which a phase change locking mechanism 130 was used. The locking mechanism 130 includes a low-melting point metal, e.g., gallium. A small volume fraction for the soft part resulted in a small quantity of gallium, and thus the hybrid fiber has only negligible bending stiffness when the gallium is solidified. With an f₂=20%, a substantial change in the membrane stiffness was obtained, around 100×, after unlocking the fiber's soft part 120. The locking mechanism 130 based on the gallium material ensured a high-load carrying capacity (14 N), faster response (<6 s), and the need of a low input power (3 W). Applications of the hybrid fibers 100 for manipulating a single-chambered soft body has been discussed. A programmable shape change in a soft body was demonstrated by selectively changing some fiber's stiffness. It is believed that this new hybrid fiber can be the best choice to obtain massive membrane stiffness changes in soft rubber-like materials without any significant bending stiffness.

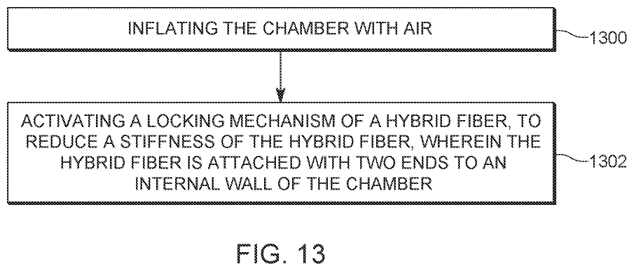

A method for controlling a shape of a chamber associated with a soft robot system is now discussed with regard to FIG. 13. The method includes a step of inflating the chamber with air to bend the chamber, and a step of activating a locking mechanism of a hybrid fiber, to reduce a stiffness of the hybrid fiber, where the hybrid fiber is attached with two ends to an internal wall of the chamber. The bending of the chamber is reduced as a result of activating the locking mechanism as the internal wall becomes less stiff. The hybrid fiber includes a stiff fiber, a soft fiber connected to the stiff fiber in series, and the locking mechanism, which is fully encapsulated within the soft fiber. The step of activating includes melting gallium in the locking mechanism.

The disclosed embodiments provide a stretchable fiber with tunable stiffness for shape-control. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Manti, M.; Cacucciolo, V.; Cianchetti, M. IEEE ROBOTICS AND AUTOMATION MAGA-ZINE 2016, 23, 93-106.
[2] Chenal, T. P.; Case, J. C.; Paik, J.; Kramer, R. K. IEEE RSJ International Conference on Intelligent Robots and Systems (IROS 2014) 2014, 2827-2831.
[3] Wang, W.; Yu, C. Y.; Serrano, P. A. A.; Ahn, S.-H. SOFT ROBOTICS 2019, 7, 283-291.
[4] Zhang, Y.-F.; Zhang, N.; Hingorani, H.; Ding, N.; Wang, D.; Yuan, C.; Zhang, B.; Gu, G.; Ge, Q. Adv. Funct. Mater. 2019, 29, 1806698.
[5] Yoshida, S.; Morimoto, Y.; Zheng, L.; Onoe, H.; Takeuchi, S. SOFT ROBOTICS 2018, 5, 718-725.
[6] Zappetti, D.; Jeong, S. H.; Shintake, J.; Floreano, D. SOFT ROBOTICS 2020, 7, 362-369.
[7] Peters, J.; Nolan, E.; Wiese, M.; Miodownik, M.; Spurgeon, S.; Arezzo, A.; Raatz, A.; Wurdemann, H. A. IEEE/RSJ International Conference on Intelligent Robots and Systems (IROS 2019) 2019, 4692-4698.
[8] Must, I.; Sinibaldi, E.; Mazzolai, B. Nature Communications 2019, 10, 344.
[9] Yuen, M. C.; Bilodeau, R. A.; Kramer, R. K. IEEE Robotics and Automation Letters 2016, 1, 708-715.
[10] Tonazzini, A.; Mintchev, S.; Schubert, B.; Mazzolai, B.; Shintake, J.; Floreano, D. Advanced Materials 2016, 28, 10142-10148.

1. A hybrid fiber with tunable stiffness, the hybrid fiber comprising:
a stiff fiber;
a soft fiber connected in series to the stiff fiber; and
a locking mechanism in contact with the soft fiber and configured to prevent the soft fiber from extending during a locked state, and to allow the soft fiber to extend during an unlocked state,
wherein the hybrid fiber has a substantially zero-bending resistance, irrespective of whether the soft fiber is in a locked or an unlocked state.

2. The hybrid fiber of claim 1, wherein the soft fiber is more stretchable than the stiff fiber, the soft fiber has a volume fraction smaller than a volume fraction of the stiff fiber, and the locking mechanism is fully encapsulated within the soft fiber.

3. The hybrid fiber of claim 1, wherein the soft fiber is stretchable while the stiff fiber is not stretchable and the soft fiber is 20% or less of a total volume of the hybrid fiber.

4. The hybrid fiber of claim 1, wherein the soft fiber has a Young modulus smaller than 0.01 GPa and the stiff fiber has a Young modulus equal to or larger than 5 GPa.

5. The hybrid fiber of claim 1, wherein the stiff fiber is made of cotton and the soft fiber is made of rubber.

6. The hybrid fiber of claim 1, wherein the locking mechanism includes gallium.

7. The hybrid fiber of claim 6, wherein the stiff fiber is directly attached to the gallium.

8. The hybrid fiber of claim 6, further comprising:
a heater located next to the gallium and configured to melt the gallium.

9. The hybrid fiber of claim 8, wherein the gallium is in solid state during the locked state, and is in a liquid state during the unlocked state.

10. A soft robot system comprising:
a chamber having in inlet for receiving pressured air;
a hybrid fiber with tunable stiffness located on an internal wall of the chamber; and
a controller configured to control an amount of air inside the chamber and a temperature inside the hybrid fiber,
wherein the hybrid fiber includes,
a stiff fiber;
a soft fiber connected in series to the stiff fiber; and
a locking mechanism configured to prevent the soft fiber from extending during a locked state, and to allow the soft fiber to extend during an unlocked state.

11. The system of claim 10, wherein the soft fiber is more stretchable than the stiff fiber.

12. The system of claim 10, wherein the soft fiber is stretchable while the stiff fiber is not stretchable.

13. The system of claim 10, wherein the soft fiber has a Young modulus smaller than 0.01 GPa and the stiff fiber has a Young modulus equal to or larger than 5 GPa.

14. The system of claim 10, wherein the stiff fiber is made of cotton and the soft fiber is made of rubber.

15. The system of claim 10, wherein the locking mechanism includes gallium.

16. The system of claim 15, wherein the stiff fiber is directly attached to the gallium.

17. The system of claim 15, further comprising:
a heater located next to the gallium and configured to heat the gallium.

18. The system of claim 17, wherein the gallium is in solid state during the locked state, and is in a liquid state during the unlocked state.

19. A method for controlling a shape of a chamber associated with a soft robot system, the method comprising:
inflating the chamber with air to bend the chamber; and
activating a locking mechanism of a hybrid fiber, to reduce a stiffness of the hybrid fiber, wherein the hybrid fiber is attached with two ends to an internal wall of the chamber,
wherein a bending of the chamber is reduced as a result of activating the locking mechanism as the internal wall becomes less stiff, and
wherein the hybrid fiber includes a stiff fiber, a soft fiber connected in series to the stiff fiber, and the locking mechanism, which is fully encapsulated within the soft fiber.

20. The method of claim 19, wherein the step of activating comprises:
melting gallium in the locking mechanism.
